(19) United States
(12) Patent Application Publication
(10) Pub. No.: US 2012/0230843 A1
(43) Pub. Date: Sep. 13, 2012

(54) COOLING SYSTEM FOR AN ELECTRIC DRIVE MACHINE AND METHOD

(75) Inventors: SREENIVASA RAVIPATI, PEORIA, IL (US); ALEXANDER CROSMAN, DUNLAP, IL (US); MATTHEW HENDRICKSON, DUNLAP, IL (US); LEWEI QIAN, PEORIA, IL (US)

(73) Assignee: CATERPILLAR INC., PEORIA, IL (US)

(21) Appl. No.: 13/042,355

(22) Filed: Mar. 7, 2011

(51) Int. Cl. F04B 49/00; B60H 1/32; G05D 23/20; G05D 23/00

(52) U.S. Cl. 417/46; 165/287; 165/271; 318/472

(57) ABSTRACT

A cooling system includes a cooling duct extending between a first component and a second component of a machine. A motor powered fan in the cooling duct creates an airflow in the duct. First and second temperature sensors are disposed to measure, respectively, first and second temperatures, which are associated with first and second temperature limits in first and second components. An electronic controller provides a motor command signal, receives the first and second temperatures, calculates first and second temperature differences to generate first and second blower commands based on the respective temperature differences, and calculates a feed-forward blower motor command based on a machine load factor. The electronic controller selects the greater of the first blower command, the second blower command, and the feed-forward blower command to be a maximum command, and determines and provides the motor command signal to the motor based on the maximum command.

### TECHNICAL FIELD

This patent disclosure relates generally to systems and methods for electric drives and, more particularly, to cooling systems and methods for cooling electric drive components of a machine.

### BACKGROUND

Cooling systems typically use circulating fluid or coolant to absorb heat from various components of the machine. The circulating fluid absorbs heat from various components thus removing it therefrom as it flows through the cooling system. The heat or thermal energy collected is removed from the fluid, typically in a radiator or another similar device.

Known cooling systems are effective in cooling various components of a vehicle but have limitations as to their operating temperatures and system requirements. For example, the heat absorption capacity of a liquid-coolant system depends on the flow rate of the coolant as well as on the total volume of coolant in the system. One disadvantage of liquid-coolant systems is their implementation in applications having weight restrictions because of the weight of the fluid and related cooling system components that are carried onboard the vehicle. In applications having both weight restrictions in addition to requiring the removal of large amount of heat, adequate cooling using a liquid-based cooling system may not be practical and may also add weight and complexity to the vehicle.

Another disadvantage of liquid-coolant systems is the electrical conductivity of the cooling medium. Because water is typically a main component of a liquid-coolant mixture, the electrical conductivity that is inherent to such mixtures makes their use unsuitable for cooling electrical components internally, such as generators and motors. Electric drive vehicles must rely on use of other mediums, such as air, for cooling. As is known, the heat capacity of air is lower than that of water or a liquid-based coolant, which means that a large volume of air must be used to match the cooling capacity of a liquid-based coolant. The energy expended to move large volumes of air around and through various components of the vehicle reduces the fuel or energy efficiency of the vehicle. Moreover, cooling systems using air, especially when used to cool more than one areas or components of the vehicle, require ducts that extend to the various components of the vehicle. Such ducts are usually large to accommodate the high volumes of air flowing to cool each components, which makes the routing of the ducts and the positioning of components in the design of the vehicle more complex and costly.

### SUMMARY

The disclosure describes, in one aspect, a cooling system that includes a cooling duct extending between a first component and a second component of a machine. A motor powered fan in the cooling duct creates an airflow in the duct. First and second temperature sensors are disposed to measure, respectively, first and second temperatures, which are associated with first and second temperature limits in first and second components. An electronic controller provides a motor command signal, receives the first and second temperatures, calculates first and second temperature differences to generate first and second blower commands based on the respective temperature differences, and calculates a feed-forward blower motor command based on a machine load factor. The electronic controller selects the greater of the first blower command, the second blower command, and the feed-forward blower command to be a maximum command, and determines and provides the motor command signal to the motor based on the maximum command

In another aspect, the disclosure describes a machine having an electric drive system. The electric drive system includes an engine that is connected to a generator. The generator has an electrical output connected to a rectifier. The rectifier is connected to an inverter, and the inverter is connected to an electric drive motor. The machine further includes a cooling duct in fluid communication with a first component and a second component of the machine. A fan motor operates a blower disposed within the cooling duct. A first temperature sensor measures a first component temperature and provides a first component temperature sensing signal. A second temperature sensor measures a second component temperature and provides a second component temperature sensing signal. An electronic controller is configured to provide a motor command signal and receive the first and second temperatures. The electronic controller calculates a first temperature difference between the first temperature and the first temperature limit and generates a first blower command for the motor based on the first temperature difference. The electronic controller further calculates a second temperature difference between the second temperature and the first temperature limit or the second temperature limit to generate a second blower command for the motor based on the second temperature difference. A feed-forward blower motor command is calculated based on a machine load factor. The electronic controller is configured to select the greater of the first blower command, the second blower command, and the feed-forward blower command to be a maximum command, and to determine and provide the motor command signal to the motor based on the maximum command.

In yet another aspect, the disclosure describes a method for operating a blower disposed in a convective cooling system associated with at least a first component and a second component of a machine. The cooling system includes a cooling duct that directs a cooling flow of air toward the first component and the second component, and a blower operating under the control of a controller to direct a cooling flow of air through the cooling duct. The method includes sensing a first temperature of the first component and providing a first temperature signal indicative of the first temperature, and sensing a second temperature of the second component and providing a second temperature signal indicative of the second temperature. The first temperature signal is compared to a first temperature limit to yield a first temperature difference, and the second temperature signal is compared to a second temperature limit to yield a second temperature difference. A first desired airflow is calculated based on the first temperature difference, and a second desired airflow is calculated based on the second temperature difference. A feed-forward airflow is determined based on at least one operating parameter of the machine that is indicative of a load factor of the machine, and the greater of the first desired airflow, the second desired airflow and the feed-forward airflow is selected to be a maximum desired airflow. The blower is operated to generate a flow of air in the cooling duct that is at least equal to the maximum desired airflow.

### BRIEF DESCRIPTION OF THE DRAWINGS

FIGS. 1A and 1B are, respectively, a front view and a side view of a machine in accordance with the disclosure.

FIG. 2 is a block diagram of a drive system for a machine in accordance with the disclosure.

FIG. 3 is a block diagram for a drive and retarding system in accordance with the disclosure.

FIG. 4 is a simplified block diagram for the drive and retarding system shown in FIG. 3.

FIG. 5 is a partial cutaway of the machine shown in FIGS. 1A and 1B.

FIG. 6 is a block diagram of a cooling system in accordance with the disclosure.

FIG. 7 is a block diagram of a cooling system in accordance with the disclosure.

FIG. 8 is a block diagram of a cooling system control in accordance with the disclosure.

### DETAILED DESCRIPTION

This disclosure relates to systems and methods for cooling drive components of an electric drive machine or vehicle. The disclosure that follows uses an example of a direct series electric drive vehicle having an engine connected to a generator for producing electrical power that drives the vehicle. In the exemplary embodiments presented, heat produced by friction or electrical energy passing through electric drive components when the machine is operating is removed and expelled to the environment. The systems and methods disclosed herein have applicability to other electric drive vehicles, including locomotives and marine applications. Additional examples for an air cooling system for an electric drive machine can be seen in U.S. patent application Ser. No. 12/150,222, which was filed on Apr. 25, 2008, and titled “Air Cooling System for Electric Drive Machine,” and which is incorporated herein in its entirety by reference. In general, a machine or vehicle may include an electric drive with power stored in one or more batteries or other storage devices, instead of being generated by an engine driven generator. This embodiment may store excess power produced during retarding in the batteries or other mechanical energy storage devices and arrangements rather than dissipating it in the form of heat.

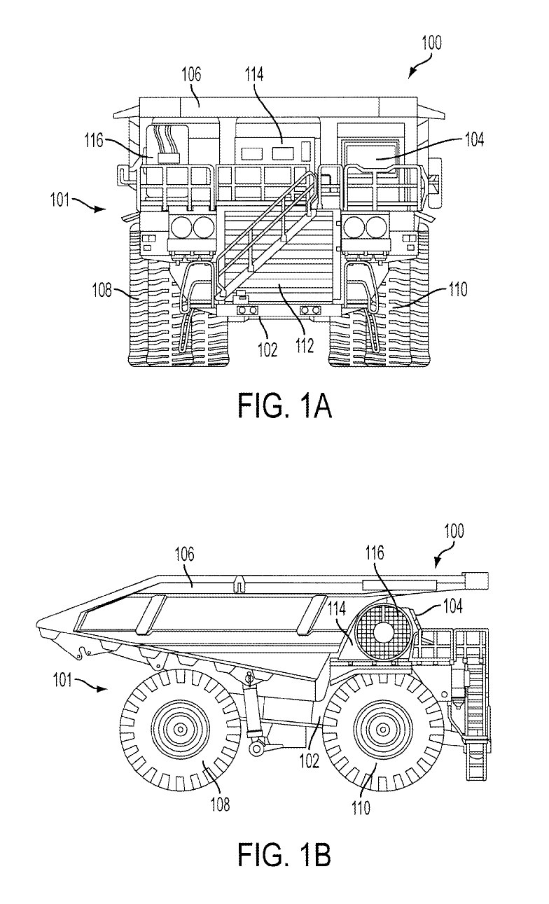

FIG. 1A and FIG. 1B illustrate, respectively, a front and a side view of a machine 100. The machine 100 is a direct series electric drive machine. One example of the machine 100 is an off-highway truck 101 such as those used for construction, mining, or quarrying. In the description that follows, this example illustrates the various arrangements that can be used on machines having direct series electric drive systems. As can be appreciated, any other vehicle having a direct series electric drive or electric-only arrangement can benefit from the advantages described herein. The term “machine,” therefore, is used to generically describe any machine having at least one drive wheel that is driven by a motor connected to the wheel. Electrical power may be generated onboard by a generator, alternator, or another power-generation device, which may be driven by an engine or other prime mover. Alternatively, electrical power may be stored but not generated onboard.

A front view of the off-highway truck 101 is shown in FIG. 1A, and a side view is shown in FIG. 1B. The off-highway truck 101 includes a chassis 102 that supports an operator cab 104 and a bucket 106. The bucket 106 is pivotally connected to the chassis 102 and is arranged to carry a payload when the off-highway truck 101 is in service. An operator occupying the operator cab 104 can control the motion and the various functions of the off-highway truck 101. The chassis 102 supports various drive system components. These drive system components are capable of driving a set of drive wheels 108 to propel the off-highway truck 101. A set of idle wheels 110 can steer such that the off-highway truck 101 can move in any direction. Even though the off-highway truck 101 includes a rigid chassis with powered wheels for motion and steerable wheels for steering, one can appreciate that other machine configurations can be used. For example, such configurations may include articulated chassis with one or more driven wheels.

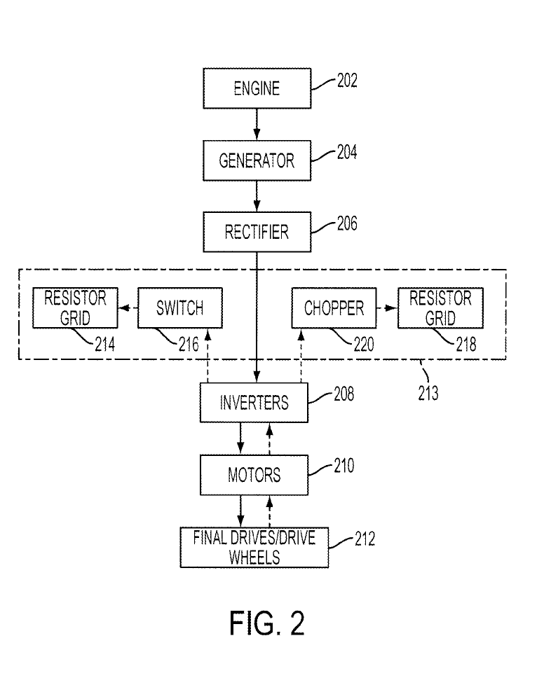

The off-highway truck 101 is a direct series electric drive machine, which in this instance refers to the use of more than one source or form of power to drive the drive wheels 108. A block diagram for the direct series electric drive system of the machine 100, for example, the off-highway truck 101, is shown in FIG. 2. In the block diagram, the flow direction of power in the system when the machine is propelled is denoted by solid-lined arrows. Conversely, the flow of power during a retarding mode is shown in dash-lined arrows. The direct series electric drive system includes an engine 202, for example, an internal combustion engine such as a diesel engine, which produces an output torque at an output shaft (not shown). The output shaft of the engine 202 is connected to a generator 204. In operation, the output shaft of the engine 202 rotates a rotor of the generator 204 to produce electrical power, for example, in the form of alternating current (AC) power. This electrical power is supplied to a rectifier 206 and converted to direct current (DC) power. The rectified DC power may be converted again to AC power by an inverter circuit 208. The inverter circuit 208 may be capable of selectively adjusting the frequency and/or pulse-width of its output, such that motors 210 that are connected to an output of the inverter circuit 208 may be operated at variable speeds. The motors 210 may be connected via final assemblies (not shown) or directly to drive wheels 212 of the machine 100.

When the off-highway truck 101 is propelled, the engine 202 generates mechanical power that is transformed into electrical power, which is conditioned by various electrical components. In an illustrated embodiment, such components are housed within a cabinet 114 (FIG. 1A). The cabinet 114 is disposed on a platform that is adjacent to the operator cab 104 and may include the rectifier 206 (FIG. 2), inverter circuit 208 (FIG. 2), and/or other components. When the off-highway truck 101 is to be decelerated or its motion is otherwise to be retarded, for example, to prevent acceleration of the machine when travelling down an incline, its kinetic energy is converted to electrical energy. Effective disposition of this generated electrical power enables effective retarding of the off-highway truck 101.

Specifically, when the machine 100 is retarding, the kinetic energy of the machine 100 is transferred into rotational power of the drive wheels that rotates the motors 210, which act as electrical generators. The electrical power generated by the motors 210 has an AC waveform. Because the inverter circuit 208 is a bridge inverter, power supplied by the motors 210 is rectified by the inverter circuit 208 into DC power. Dissipation of the DC power generated by the motors 210 produces a counter-rotational torque at the drive wheels 108 to decelerate the machine. Dissipation of this DC power may be accomplished by passing the generated current rectified by the inverter circuit 208 through a resistance. To accomplish this, a retarder arrangement 213 may include a first resistor grid 214, described in greater detail below, that is arranged to receive current from the inverter circuit 208 via a switch 216. When the switch 216 is closed, the electrical power corresponding to the current generated by the motors 210 may pass through the first resistor grid 214 and be dissipated as heat. Additionally, excess electrical power is also dissipated as heat as it passes through a second resistor grid 218, which is arranged to receive electrical power via a chopper circuit 220. The chopper circuit 220 operates to selectively route a portion of the developed electrical power through the second resistor grid 218. One embodiment for the drive and retarding system is described in more detail below.

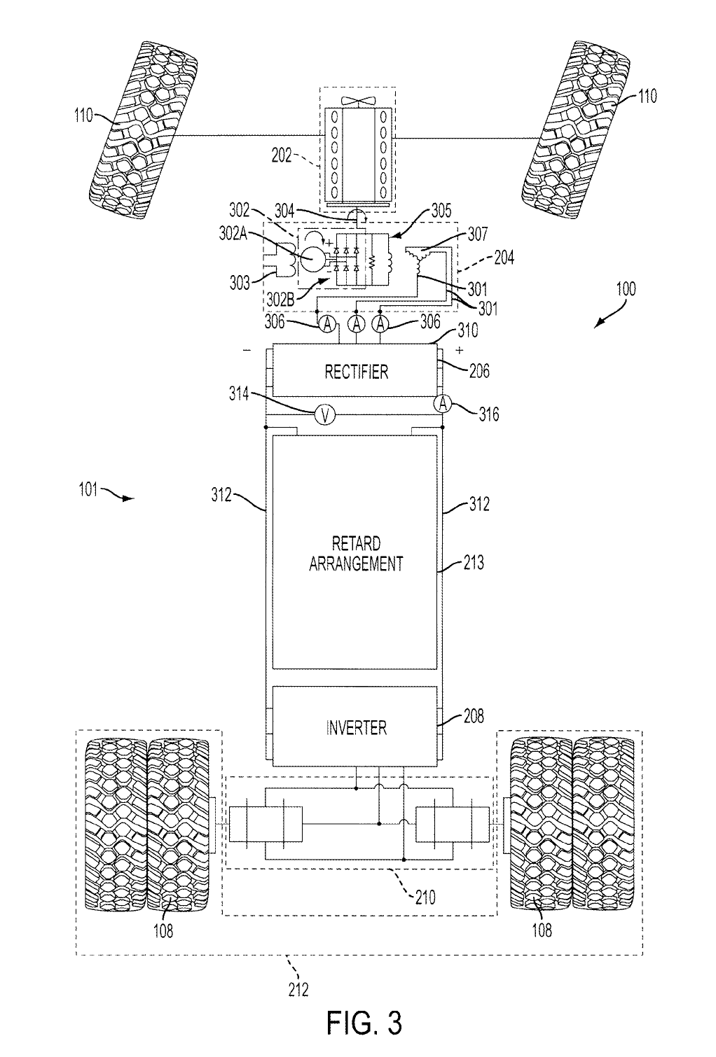

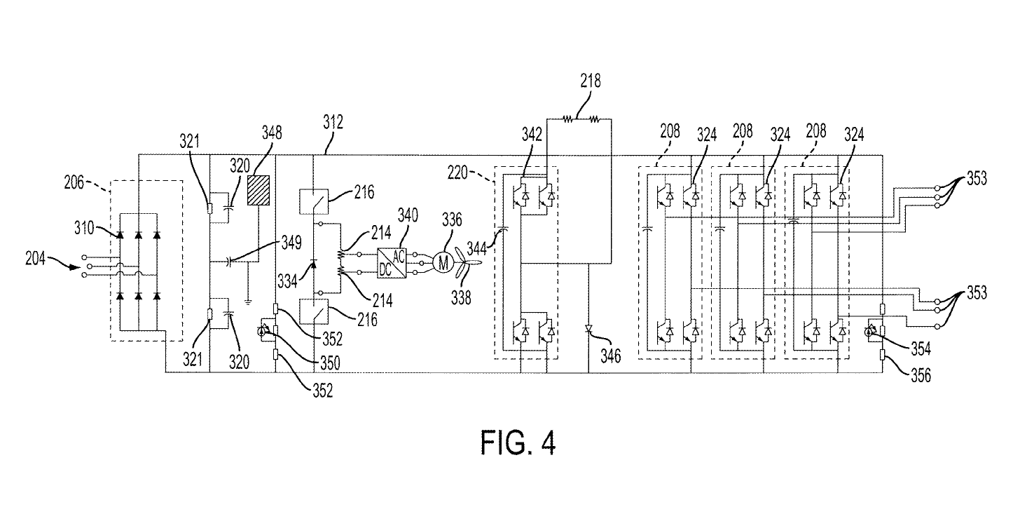

A block diagram of the direct series electric drive system of the off-highway truck 101, as one example for the machine 100, is shown in FIG. 3 and FIG. 4. In these views, elements that were previously described are denoted by the same reference numerals for the sake of simplicity. Further, the block diagram of FIG. 4 includes a particular embodiment with component examples that can be included in the functional blocks shown in FIG. 3. Hence, the block diagrams shown in FIG. 3 and FIG. 4 should be referred to together when considering the description that follows. As shown, the engine 202 is connected to the generator 204 (shown in FIG. 3) via an output drive shaft 304. Even though a direct connection to the output drive shaft 304 is shown, other drive components, such as a transmission or other gear arrangements, may be utilized to couple the output of the engine 202 to the generator 204. The generator 204 may be any appropriate type of generator or alternator known in the power generation art.

In one embodiment, the generator 204 is a three-phase alternating current (AC) synchronous generator having a brushless, wound rotor. The generator 204 has an output 301 for each of three phases of alternating current being generated, with each output having a respective current transducer 306 connected thereto. The rotor of the generator 204 (shown in FIG. 3) includes a rotating rectifier 302 that is connected to a rotating exciter armature 302A. The rotating exciter armature 302A is energized by an excitation field produced by an excitation winding 303. Thus, the application of an excitation signal at the input to the winding 303 creates an excitation field to activate the generator field 305. The generator field 305, in turn, produces the output available at three leads of the armature 307 of the generator 204.

In the illustrated embodiment, the rotating rectifier 302 includes a rotating exciter armature 302A that is connected to a series of rotating diodes 302B. The three current outputs of the generator 204, which are collectively considered the output of the generator 204, are connected to a rectifier 206. Other generator arrangements may alternatively be used.

The rectifier 206 converts the AC power supplied by the generator 204 into DC power. Any type of rectifier 206 may be used. In the example shown, the rectifier 206 includes six power diodes 310 (best shown in FIG. 4) that are arranged in diode pairs around each phase of the output of the generator 204. Each diode pair includes two power diodes 310 that are connected in series to each other, with a connection to each phased output of the generator 204 between each pair. The three pairs of power diodes 310 are connected in parallel to each other and operate to develop a voltage across a DC linkage or DC link 312. This DC link voltage is available at a first rail and a second rail of the DC link 312. The first rail is typically at a first voltage and the second rail is typically at a second voltage during operation. Either of the first and second voltages may be zero.

During operation, a voltage is supplied across the first and second rails of the DC link 312 by the rectifier 206 and/or an inverter circuit 208. One or more capacitors 320 may be connected in parallel with one or more resistors 321 across the DC link 312 to smooth the voltage V across the first and second rails of the DC link 312. The DC link 312 exhibits a DC link voltage, V, which can be measured by a voltage transducer 314, and a current, A, which can be measured by a current transducer 316, as shown in FIG. 3.

The inverter circuit 208 is connected in parallel with the rectifier 206 and operates to transform the DC voltage V into variable frequency sinusoidal or non-sinusoidal AC power that powers, in this example, two drive motors 210 (FIG. 3). Any known inverter may be used for the arrangement of the inverter circuit 208. In the example shown in FIG. 4, the inverter circuit 208 includes three phase arrays of insulated-gate bipolar transistors (IGBT) 324 that are arranged in transistor pairs and that are configured to supply a 3-phase AC output to each drive motor 210.

The inverter circuit 208 can control the speed of the motors 210 by controlling the frequency and/or the pulse-width of the AC output. The drive motors 210 may be directly connected to the drive wheels 108 or, as in the example shown in FIG. 3, may power the final drives that power the drive wheels 212. Final drives, as is known, operate to reduce the rate of rotation and increase the torque between each drive motor 210 and each set of drive wheels 212.

In alternative embodiments, the engine 202 and generator 204 are not required to supply the power necessary to drive the drive motors 210. Instead, such alternative embodiments use another source of power, such as a battery or contact with an electrified rail or cable. In some embodiments, one drive motor 210 may be used to power all drive wheels of the machine, while in other embodiments, any number of drive motors may be used to power any number of drive wheels, including all wheels connected to the machine.

Returning now to the block diagrams of FIG. 3 and FIG. 4, when the machine 100 operates in an electric braking mode, which is also known as electric retarding, less power is supplied from the generator 204 to the DC link 312. Because the machine is travelling at some non-zero speed, rotation of the drive wheels 108 due to the kinetic energy of the machine 100 will power the drive motors 210. The drive motors 210, in this mode, act as generators by producing AC electrical power. Consumption or disposition of this electrical power will consume work and act to apply a counter-rotational torque on the drive wheels 108, causing them to reduce their rotational speed, thus retarding the machine.

The generated AC electrical power can be converted into DC electrical power through the inverter circuit 208 for eventual consumption or disposition, for example, in the form of heat. In an illustrated embodiment, a retarder arrangement 213 consumes such electrical power generated during retarding. The retarder arrangement 213 can include any suitable arrangement that will operate to dissipate electrical power during retarding of the machine. In the exemplary embodiments shown in FIG. 4, the retarder arrangement 213 includes a first resistor grid 214 that is arranged to dissipate electrical energy at a fixed rate. The retarder arrangement 213 also includes a second resistor grid 218, to which DC current is supplied at a selectively variable rate by use of a pulse width modulator (PWM) or chopper circuit 220. In this way, the second resistor grid 218 dissipates electrical energy at a variable rate.

When the machine 100 is to operate in a retarding mode, the first resistor grid 214 is connected between the first and second rails of the DC link 312 so that current may be passed therethrough. When the machine 100 is being propelled, however, the first resistor grid 214 is electrically isolated from the DC link 312 by two contactors or bipolar automatic switches (BAS) 216. Each BAS 216 may include a pair of electrical contacts that are closed by an actuating mechanism, for example, a solenoid (not shown) or a coil creating a magnetic force that attracts the electric contacts to a closed position. The BAS 216 may include appropriate electrical shielding and anti-spark features that can allow these items to operate repeatedly in a high voltage environment.

When the machine 100 initiates retarding, it is desirable to close both BAS 216 within a relatively short time period such that the first resistor grid 214 is placed in circuit between the first and second DC rails to begin energy dissipation rapidly. Simultaneous actuation or actuation at about the same time, such as, within a few milliseconds, of the pair of BAS 216 may also advantageously avoid charging the first resistor grid 214 and other circuit elements to the voltage present at the rails of the DC link 312. The pair of BAS 216 also prevents exposure of each of the BAS 216 or other components in the system to a large voltage difference (the voltage difference across the DC link 312) for a prolonged period. A diode 334 may be disposed in parallel to the first resistor grid 214 to reduce arcing across the BAS 216, which also electrically isolates the first resistor grid 214 from the DC link 312 during a propel mode of operation.

When the machine 100 is retarding, a large amount of heat can be produced by the first resistor grid 214. Such energy, when converted to heat, must be removed from the first resistor grid 214 to avoid an overheating condition. For this reason, a blower 338, driven by a motor 336, operates to convectively cool the first resistor grid 214. There are a number of different alternatives available for generating the power to drive the motor 336. In this embodiment, a DC/AC inverter 340 is arranged to draw power from voltage-regulated locations across a portion of the first resistor grid 214. The DC/AC inverter 340 may advantageously convert DC power from the DC link 312 to 3-phase AC power that drives the motor 336 when voltage is applied to the first resistor grid 214 during retarding.

In the illustrated embodiment, the BAS 216 are not arranged to modulate the amount of energy that is dissipated through the first resistor grid 214. During retarding, however, the machine 100 may have different energy dissipation requirements. This is because, among other things, the voltage V in the DC link 312 should be controlled to be within a predetermined range. To meet such dissipation requirements, the second resistor grid 218 can be exposed to a controlled current during retarding through action of the chopper circuit 220. The chopper circuit 220 may have any appropriate configuration that will allow modulation of the current supplied to the second resistor grid 218. In this embodiment, the chopper circuit 220 includes an arrangement of transistors 342 that can, when actuated according to a desired frequency and/or duration, modulate the current passed to the second resistor grid 218. This controls the amount of energy dissipated by the second resistor grid 218 during retarding. The chopper circuit 220 may additionally include a capacitor 344 that is disposed between the first and second rails of the DC link 312 and that regulates the voltage input to the chopper circuit 220. A bistable switch or thyristor 346 may be connected between the second resistor grid 218 and the DC link 312 to protect against short circuit conditions in the DC link 312.

The passage of current through the second resistor grid 218 will also generate heat, necessitating cooling of the second resistor grid 218. In this embodiment, the first and second resistor grids 214 and 218 may both be located within the blower housing 116 (also shown in FIG. 1A and FIG. 2) for convective cooling when the motor 336 and blower 338 are active.

The embodiment for a drive system shown in FIG. 4 includes other components that are discussed for the sake of completeness. Such components are optional but are shown herein because they promote smooth and efficient operation of the drive system. In this exemplary embodiment, a leakage detector 348 is connected between the two resistors 321, in parallel with a capacitor 349, to the first and second rails of the DC link 312. The leakage detector 348 detects any current leakage to ground from either of the first and second rails of the DC link 312. Further, in one embodiment, a first voltage indicator 350 may be connected between resistors 352 across the first and second rails of the DC link 312. The first voltage indicator 350 may be disposed between the rectifier 206 and the retarder arrangement 213 such that a high voltage condition may be detected. In a similar fashion, a second voltage indicator 354 may be connected between resistors 356 across the first and second rails of the DC link 312. The second voltage indicator 354 may be disposed between connection nodes 353 that connect to the drive motors 210 and the inverter circuit 208 to detect a voltage condition occurring during, for example, a bus bar fracture where the DC link 312 is not continuous, to diagnose whether the inverter is operating.

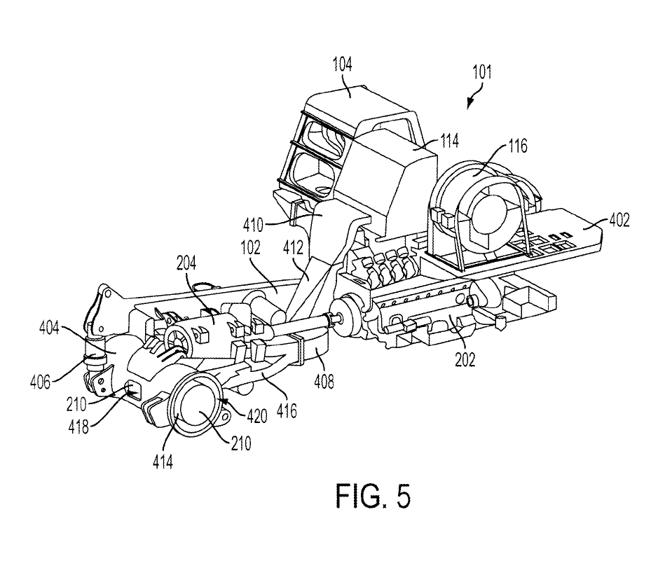

FIG. 5 is a partial cut-away of the off-highway truck 101 of FIGS. 1A and 1B. In this cutaway view, portions of the off-highway truck 101 have been removed or cut-away to reveal components belonging to a drive system. Components that have been previously described are denoted by the same reference numerals as previously used for the sake of simplicity. The operator cab 104 is subtended by the chassis 102, which also supports other drive system components either directly or indirectly. For example, a platform 402 that is connected to the chassis 102 may support the blower housing 116 and the cabinet 114 (also shown in FIGS. 1A and 1B). Appropriate structures may further connect the engine 202 and the generator 204 to the chassis 102. In this exemplary embodiment, two drive motors 210 are enclosed within a hollow axle assembly 404, which is connected to the chassis 102 via a plurality of structures (not shown) and shock absorbers 406 (only one shown).

Various electrical components of the drive system may, or contain within them other components that, generate heat during operation. For example, the cabinet 114 may house the rectifier circuit 206 (FIG. 2), the chopper circuit 220 (FIG. 2), and/or the inverter circuits 208 (FIG. 2), each of which may generate heat during operation. Similarly, the generator 204 and motors 210 may include bearings or wiring, such as wiring comprising their windings. These components generate heat, either by friction in the case of the bearings, or due to the resistance of the wiring when current flows therethrough. It may be desirable to avoid such heating of components to ensure proper operation over a prolonged service life. For this reason, a cooling duct assembly 408 that is capable of directing a cooling flow of air passing therethrough by action of a fan (not shown) can be arranged to direct the cooling air flow toward one or more components of the machine 100.

In the embodiment shown in FIG. 5, the cooling duct assembly 408 includes an inlet or head portion 410 that is connected to the cabinet 114. In the disclosed embodiment, the head portion 410 has a flat rectangular cross section that transitions to a square cross section, and is arranged to pull air from within the cabinet 114 into the cooling duct assembly 408 such that components operating within the cabinet 114 can be convectively cooled. The head portion 410 is appropriately shaped to smoothly route an airflow from the cabinet 114 into a main portion 412 of the cooling duct assembly 408. The main portion 412 includes a generally upright section that is in fluid communication with the head portion 410, and a generally longitudinal section that is in fluid communication with the upright section. The main portion 412 may house the fan (not shown) at a section thereof such that operation of the fan acts to pull air into the cooling duct assembly 408, and push a flow of air through the various portions of the cooling duct assembly 408.

One component arranged to receive air from the cooling duct assembly is the generator 204. Air travelling through the main portion 412 may be partially or entirely routed toward the generator 204. The generator 204 may have appropriate internal passages that permit airflow therethrough for cooling. The generator 204 may alternatively have external features, such as fins, which may promote the flow of air over surfaces of the generator 204 to promote convective cooling.

The main portion 412 of the cooling duct assembly 408 may further be fluidly connected to an internal cavity 414 that is defined within the hollow axle assembly 404. In one embodiment, the internal cavity 414 at least partially encloses or contains the motors 210. Air travelling through the main portion 412 may be routed to the internal cavity 414, either directly from the main portion 412, or alternatively via one or more runners 416, which are optional. Such air flow convectively cools the motors 210. The airflow within the internal cavity 414, and the heat it has absorbed along its path through the cooling duct assembly 408, may be expelled into the environment via an opening 418 formed in the hollow axle assembly 404. Alternatively, heat may be expelled via other openings, for example, a pair of openings 420 formed close to each end of the hollow axle assembly 404.

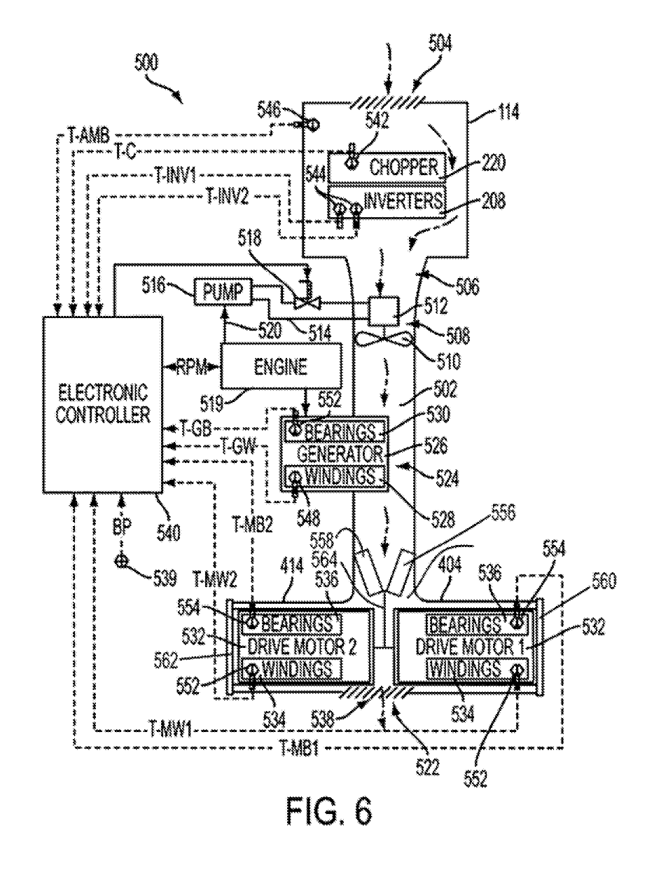

A block diagram showing the various components and systems that are associated with a cooling duct arrangement in accordance with the disclosure is shown in FIG. 6. As shown therein, a cooling system 500 for use with an electric drive machine 100 (FIG. 1A) includes a cooling duct 502 that substantially surrounds or at least fluidly interacts with various components. The cooling duct 502 has an inlet opening 504 that may be integrated with a component of the machine, for example, the cabinet 114 (FIG. 5). The inlet opening 504 may lead to an inlet portion 506 of the cooling duct 502, which in turn may lead to a fan portion 508. The fan portion 508 may house a fan 510 that is operated by a fan motor 512. The fan motor 512 may be of any appropriate type of device that is driven by any known motive energy type, for example, electrical, hydraulic, pneumatic, mechanical, and so forth.

In the disclosed embodiment, the fan motor 512 is a hydrostatic motor that is disposed within the fan portion 508 and operates by a flow of hydraulic fluid passing through conduits 514. The circulating flow may be impelled by a pump 516. The speed of the fan motor 512 may be controlled by a solenoid valve 518 and may be measured by a sensor (not shown). The control arrangement for controlling the speed of the fan motor 512 may be any number of arrangements. For example, the solenoid valve 518 may shunt or otherwise restrict a portion of the flow of fluid impelled by the pump 516 from reaching the fan motor 512. Similarly, the pump 516 may be driven by the engine 519 of the machine via an input shaft 520 or by any other appropriate method.

During operation, the fan 510 creates air flow through the cooling duct 502. Such airflow through the cooling duct 502 is denoted by dot-dash-dot lined and open headed arrows. This flow of air may enter through the inlet opening 504 and travel the entire length of the cooling duct 502 before exiting via one or more outlet opening(s) 522 defined in the cooling duct 502. Along its path, the airflow may pass over and/or through various components that require convective cooling.

The cooling duct 502 may form a generator portion 524 that at least partially envelopes a portion or passes through a portion of a generator 526 of the machine. The generator 526 may be the generator 204 shown in FIG. 2, and airflow within the cooling duct 502 may convectively cool the generator 526 during operation. The generator 526 has various components, some of which are more sensitive to high temperature than others. Components of the generator that are expected to generate heat during operation include the windings 528 and the rotor bearings 530 of the generator 204. Thus, airflow from the cooling duct 502 may be arranged to pass over or through at least portions of the generator windings 528 and the rotor bearings 530 to cool the same.

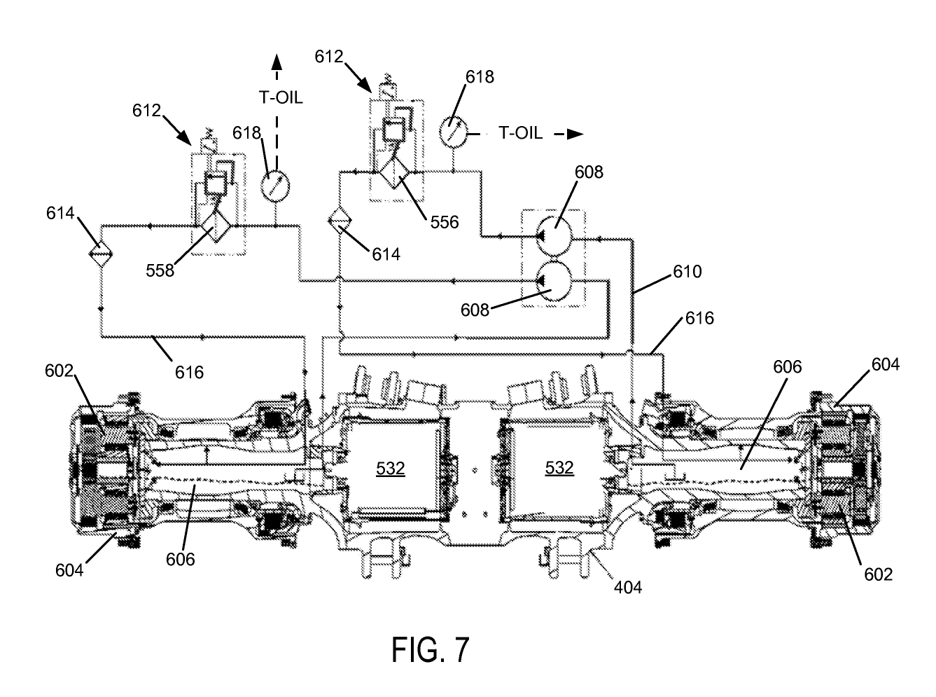

The cooling duct 502 may further be fluidly connected to the internal cavity 414 defined within the hollow axle assembly 404 (FIG. 5). In this embodiment, the cooling duct 502 encloses two motors 532. Each of the motors 532 may include a respective motor winding 534 and respective motor bearings 536. The cooling duct further encloses one or more final drive oil coolers. In the illustrated embodiment, two final drive oil coolers 556 and 558 are positioned within the cooling duct 502. The final drives and associated cooling oil system are shown in FIG. 7 and are discussed in the paragraphs that follow. Each oil cooler 556 and 558 is a liquid-to-air cooler configured to convectively cool oil passing therethrough when a flow of air is present in the cooling duct 502. The extent of cooling provided by the coolers 556 and 558 depends on the rate of airflow in the cooling duct 502. As can be appreciated, the airflow within the cooling duct 502 may be arranged to pass over or through portions of the coolers 556 and 558, and the various motor components such that they are cooled during operation. In the illustrated embodiment, a divider wall 564 is disposed to separate the air flow through the cooling duct 502 after the coolers 556 and 558 into two streams, each of which is provided to the right and left sides of the hollow axle assembly 404.

The airflow within the cooling duct 502, having passed over the various components of the drive system described above, may be expelled into the environment through the one or more outlet opening(s) 522. The exiting airflow carries with it the thermal energy that was removed when the various components that communicate with the cooling duct 502 were convectively cooled. In the embodiment shown in FIG. 6, the one or more outlet opening(s) 522 are shown as a single opening 538 that may be covered by louvers. However, the position of the louvers and the number of openings may be altered, and other configurations may be used.

The cooling system thus far has been described relative to its structure. Activation of the fan 510 when it is determined that various components require cooling is also described herein. It can be appreciated that continuous operation of the fan 510 would likely reduce the fuel efficiency of the machine 100. Hence, the fan 510 should operate in a mode that is both fuel efficient and which provides adequate cooling to the various components of the machine. This can be accomplished via an electronic controller 540, which is disposed to receive temperature information from the various components that are associated with the cooling duct 502. The controller 540 operates in a logical fashion in response to these data to control the operation of the fan 510.

The electronic controller 540 is connected to various temperature sensors or transducers throughout the system. Examples of such sensors and their placement, which are meant as illustrative and non-limiting examples, include a chopper circuit temperature sensor 542 disposed proximate to the chopper circuit 220. The inverter circuits 208 may include one or more inverter temperature sensor(s) 544 (two shown) that are appropriately positioned in areas thereof that are sensitive to high temperatures. Such locations may be adjacent to electronic components that include integrated control circuits, transistors, and so forth. An ambient temperature sensor 546 may be optionally installed within the cabinet 114 to measure the temperature of air (T-AMB) that circulates within the cabinet 114. Air circulating within the cabinet 114, in one embodiment, is air that eventually forms the airflow passing through the cooling duct 502.

Other components of the drive system may also include temperature sensors to measure the temperature of various internal components thereof. For example, the generator 526 may include a generator winding temperature sensor 548 that is disposed to measure the temperature of the windings 528 (T-GW) of the generator 526. A rotor bearing temperature sensor 550 is disposed to measure the temperature of the rotor bearings 530 (T-GB). Similarly, each drive motor 532 may include a respective motor winding temperature sensor 552, disposed to measure the temperature of the windings 534 (T-MW1 and T-MW2) of each motor 532. A respective motor bearing temperature sensor 554 is disposed to measure the temperature of the bearings 536 (T-MB1 and T-MB2) in each motor 532. A respective final drive oil temperature sensor 560 and 562 is also associated with each of the two final drive oil coolers 556 and 558 shown in FIG. 6.

These various temperature sensors may be operatively connected to the electronic controller 540 and disposed to communicate information indicative of the various temperatures being measured. Some of the interconnections between the electronic controller 540 and various sensors in the cooling system are denoted by dotted lines in FIG. 6. The connections between the various temperature sensors and the electronic controller may be accomplished via any known method, and the signals communicated by the temperature sensors may be of any appropriate type, for example, digital signals, analog signals, signals sent through a controller area network (CAN) link, and so forth. The electronic controller 540 may be disposed to receive additional information relative to the operating parameters of the machine, for example, the barometric pressure (BP) measured by a pressure sensor 539, the engine speed (RPM) of the engine 519, and so forth, which are measured by appropriate sensors disposed on the machine and connected to the electronic controller 540. The electronic controller 540 is also operatively connected to the valve 518 controlling the flow of hydraulic fluid from the pump 516 to the fan motor 512. The electronic controller 540 may generate a motor control signal that is communicated to the valve 518 and that results in operating the fan motor 512 at a desired rotational speed.

A block diagram for a cooling system 600 associated with the final drive oil coolers 556 and 558 is shown in FIG. 7, where elements and features that are the same or similar to corresponding elements and features already described are denoted by the same reference numerals as previously used for simplicity. The cooling system 600 configured to provide a flow rate of oil or another coolant to two final drives 602 of the hollow axle assembly 404, which is shown in cross section. Each final drive 602 includes a set of intermeshed gears having an appropriate gear ratio to transmit rotation of the output of each motor 532 to a respective hub 604, onto which one or more wheels 108 (shown, for example, in FIG. 3) are connected. An oil sump cavity 606 is defined within the hollow axle assembly 404 between each motor 532 and its respective final drive 602.

During operation of the cooling system 600, oil is provided to the gears in the final drives 602 for lubrication and cooling. To circulate the oil, a pump 608 is configured to draw oil from the oil sump cavity 606 via a supply line 610. In the illustrated embodiment, two pumps 608 are shown, one corresponding to each final drive 602. Oil from each pump 608 is provided to the corresponding final drive oil cooler 556 or 558. Depending on the temperature of the oil, a thermostat assembly 612 can selectively bypass the coolers 556 and/or 558. The flow of oil from the coolers 556 and 558 is optionally filtered by passing through a respective filter 614 before being supplied to the respective final drive 602 via a return line 616. The cooling system further includes temperature sensors 618 configured to measure the temperature of oil incoming to the coolers 556 and 558, and provide a signal indicative of that temperature, T-OIL, to the electronic controller 540 (FIG. 6).

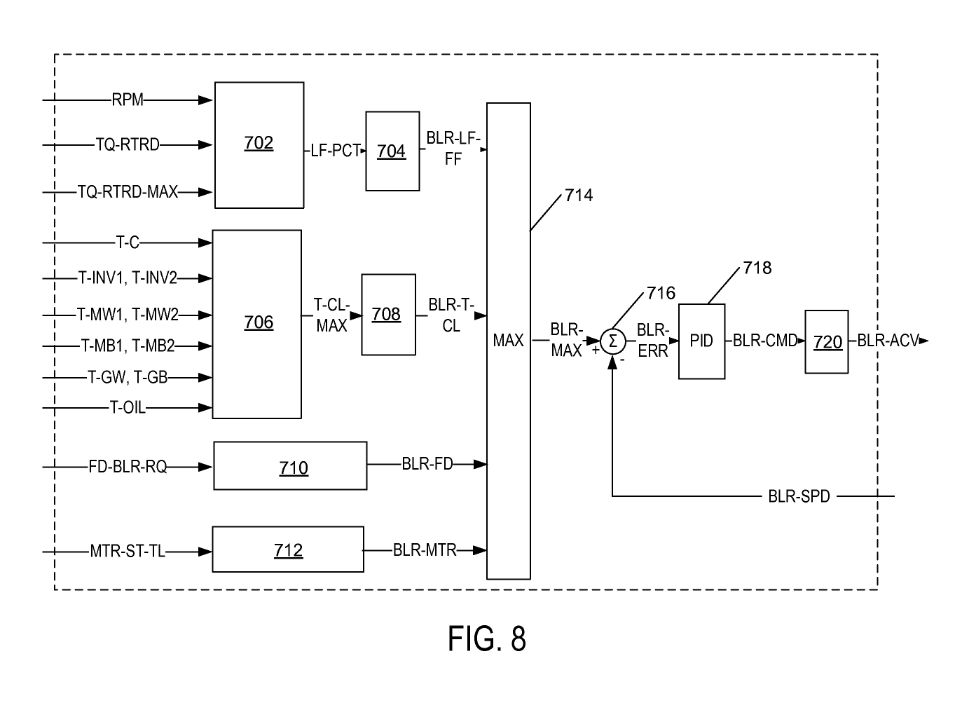

A block diagram of a cooling system control 700 is shown in FIG. 8. The control 700 is configured to operate the fan motor 512 such that sufficient cooling is provided to the various components and systems directly and indirectly associated with the cooling duct 502. In the illustrated embodiment, the control 700 includes a feed forward function 702 configured to determine a percent (%) load factor for the drive train of the machine 100, which is denoted as LF-PCT in FIG. 8 and which is indicative of the percent utilization of the power output of the propel and other systems of the machine during operation. This determination may be performed using any appropriate parameters processed by any appropriate method. As shown, inputs to the feed forward function 702 include engine speed (RPM), a braking or retard torque request (TQ-RTRD), an a maximum available retard torque that is available (TQ-RTRD-MAX). The RPM is indicative of the power output of the machine, while the various retard torque requests are indicative of the energy inertia of the machine during operation. Because these parameters can have an appreciable impact to the operating temperature and heating of the various machine components and systems, they are used to determine, for example, by use of a three dimensional table or model, a baseline indication of the cooling that will be required.

The LF-PCT is provided to a blower speed calculation function 704, which is configured to determine the appropriate blower speed based on the load factor of the machine, for example, by correlating the two parameters in a two-dimensional interpolation lookup table. The output of the blower speed calculation function 704 is a feed forward desired blower speed request that is based on the load factor, which is denoted in FIG. 8 as BLR-LF-FF.

The control 700 further includes a closed loop temperature comparator 706, which is configured to receive various temperature signals from components throughout the machine, compare each to its respective maximum limits, and provide a signal indicative of the smallest margin between the temperature of any component to its respective temperature limit. In the illustrated embodiment, the closed loop temperature comparator 706 is configured to receive the chopper circuit temperature (T-C), the inverter circuit temperatures (T-INV1 and T-INV2), the drive motor winding temperatures (T-MW1 and T-MW2), the drive motor bearing temperatures (T-MB1 and T-MB2), the generator winding temperature (T-GW) and bearing temperature (T-GB), the final drive oil temperatures (T-OIL), and other parameters. Each of these parameters may be compared to a respective temperature limit individually or in groups. The temperature comparator 706 provides a maximum closed loop temperature, T-CL-MAX, which may be a normalized, non-dimensional parameter. The maximum temperature T-CL-MAX is provided to a temperature driven blower speed calculation function 708, which is configured to determine the appropriate blower speed that provides sufficient cooling to the component being closest to its temperature limit based on the maximum closed loop temperature T-CL-MAX. The output of the temperature driven blower speed calculation function 708 is a closed loop temperature desired blower speed request, BLR-T-CL, which is indicative of a desired blower speed that will provide sufficient cooling to a component having a temperature that is closest to the component's desired temperature limit.

The control 700 is configured to further receive a parameter indicative of other machine parameters that are related to cooling needs of components associated with the cooling duct 502. Any appropriate parameters may be used. In the illustrated embodiment, two parameters are shown but other parameters instead of or in addition to the two parameters shown may be used. As shown, the control 700 is configured to receive a parameter indicative of a final drive blower speed request, FD-BLR-REQ. The FD-BLR-REQ is indicative of the degree of cooling that is required to bring a coolant, such as oil, that lubricates and cools the machine's final drives 602 (FIG. 7) to a desired temperature. The FD-BLR-REQ parameters may also be based on parameters other than the T-OIL. For example, the FD-BLR-REQ may be based on machine duty cycle parameters that are related to the severity of work that is input or that is expected to be input to the final drives. Given the relatively high thermal inertia of the final drives 602, the FD-BLR-REQ may be determined based on a probability that the temperature of the final drives 602 will tend to increase, such as under conditions when the machine is loaded and a controller determines that the machine will be travelling on an incline. The FD-BLR-REQ is provided to a lookup table or other function 710, which determines and provides a final drive blower speed request BLR-FD.

Another parameter provided to the control 700 in the illustrated embodiment is indicative of whether certain short term temperature limits are approached by the electric motors 532 (FIG. 6). Much like the final drive blower speed request FD-BLR-REQ, a short term temperature limit status of the motors, MTR-ST-TL, parameter may be indicative that the motors 532 are expected/predicted to be close to their temperature limits in the near future. For example, under operating conditions when the machine is loaded and travelling on an incline, the motors acting to propel or retard the machine may undergo temperature changes. Given the relatively large heat inertia of the motors and the drive system of the machine in general, parameters such as the MTR-ST-TL and FD-BLR-REQ are useful in avoiding temperature overshoot conditions in various machine components. As before, the MTR-ST-TL is provided to a lookup table or other function 712, which determines and provides a short term motor blower speed request BLR-MTR.

The feed-forward blower request based on the load factor of the machine, BLR-LF-FF, the closed loop temperature based blower request, BLR-T-CL, and the motor and final drive blower speed requests BLR-FD and BLR-MTR, are all continuously calculated and simultaneously provided to a maximum value determinator (MAX) 714. The MAX 714 function is configured to monitor the various blower speed requests and select the largest speed requested, BLR-MAX to be a setpoint speed for controlling the operation of the fan motor 512 (FIG. 6). One possible control scheme that can be used is a proportional, integral and derivative term controller (PID), but other control schemes can be used.

The BLR-MAX setpoint is provided to summing junction 716 that calculates a blower speed error, BLR-ERR, as a difference between the setpoint BLR-MAX and a measured or otherwise determined blower speed, BLR-SPD. The error value BLR-ERR is provided to a control function 718, which in the illustrated embodiment is a PID type controller. Although a PID is shown, any other appropriate type of control scheme may be used, such as model-based algorithms and the like. The PID 718 is configured to provide a blower command signal, BLR-CMD, to a blower motor transfer function 720. The blower motor transfer function 720 is configured to receive the blower command signal BLR-CMD and provide an appropriate activation signal, BLR-ACV, that causes the fan motor 512 to rotate the fan 510 (FIG. 6) such that an airflow and/or blower speed corresponding to the blower command signal BLR-CMD is provided within the cooling duct 502. In the embodiment illustrated in FIG. 6, for example, the BLR-ACV may be a current signal provided to the solenoid valve 518. A blower speed sensor (not shown) or any other appropriate method may be used to measure or determine the blower speed BLR-SPD that is provided as feedback to the PID 718 as previously described.

### INDUSTRIAL APPLICABILITY

The present disclosure is applicable to many machines and many environments. One exemplary machine suited to the disclosure is large off-highway trucks, such as dump trucks. Exemplary off-highway trucks are commonly used in mines, construction sites and quarries. The off-highway trucks may have payload capabilities of 100 tons or more and travel at speeds of 40 miles per hour or more when fully loaded. The trucks operate in a variety of environments and must be able to cope with high ambient temperatures.

The embodiments for drive system cooling arrangements and methods disclosed herein have universal applicability of various applications having one or more electric drive system components being actively cooled by forced convection. One can appreciate that the cooling duct disclosed herein may be designed to deliver a flow of cooling air to various components of a vehicle that are disposed in any arrangement. Similarly, the methods and control algorithms disclosed herein are capable of controlling the operation of a cooling fan or blower such that the individual cooling needs of one or more components can be accommodated while still promoting operation of the machine in a fuel or energy efficient manner.

Moreover, the methods and systems described above can be adapted to a large variety of machines and tasks. For example, backhoe loaders, compactors, feller bunchers, forest machines, industrial loaders, skid steer loaders, wheel loaders, locomotives, marine applications and many other machines can benefit from the methods and systems described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A cooling system for cooling one or more components of an electric drive system in a machine, comprising:
a cooling duct extending between a first component and a second component of the machine;
a fan disposed to create an airflow within the cooling duct when the fan is operating;
a motor disposed to rotate the fan;
a first temperature sensor disposed to measure a first temperature of the first component, the first temperature being associated with a first temperature limit;
a second temperature sensor disposed to measure a second temperature of the second component, the second temperature being associated with a second temperature limit;
an electronic controller configured to:
provide a motor command signal;
receive the first and second temperatures;
calculate a first temperature difference between the first temperature and the first temperature limit and generate a first blower command for the motor based on the first temperature difference;
calculate a second temperature difference between the second temperature and the second temperature limit to generate a second blower command for the motor based on the second temperature difference;
calculate a feed-forward blower motor command based on a machine load factor;
select the greater of the first blower command, the second blower command, and the feed-forward blower command to be a maximum command, and
determine and provide the motor command signal to the motor based on the maximum command.

2. The cooling system of claim 1, wherein the first component and the second component are at least two of a chopper circuit, an inverter circuit, a generator bearing, a generator winding, a motor bearing, a motor winding, a final drive, and a final drive oil cooler that are operably associated with the machine.

3. The cooling system of claim 1, further including an engine speed sensor disposed to measure a speed of an engine associated with the machine, wherein the electronic controller is configured to determine the load factor of the machine based at least partially on an engine speed signal provided to the electronic controller by the engine speed sensor.

4. The cooling system of claim 1, further including a speed sensor disposed to measure a rotational speed of the motor and communicate a fan speed to the electronic controller, wherein the electronic controller is disposed to use the fan speed in a closed loop control system that controls the operation of the motor.

5. The cooling system of claim 1, further including:
a pump operating to circulate a flow of fluid through conduits that are connected to the motor; and
a proportional valve disposed to selectively modulate a flow rate of the flow of fluid in the conduits;
wherein fan motor is a hydrostatic motor whose rotational speed depends on a setting of the proportional valve, and
wherein the motor command signal is configured to adjust the setting of the proportional valve.

6. The cooling system of claim 1, wherein the machine further includes a hollow drive axle forming a cavity, wherein the first component is a liquid-to-air cooler disposed at least partially within the cooling duct, the liquid-to-air cooler arranged to cool a flow of coolant circulating through a final drive of the machine.

7. A machine having an electric drive system, the electric drive system including an engine that is connected to a generator, the generator having an electrical output connected to a rectifier, the rectifier connected to an inverter, the inverter connected to an electric drive motor, the machine further comprising:
a cooling duct in fluid communication with a first component and a second component;
a fan motor operating a blower disposed within the cooling duct;
a first temperature sensor disposed to measure a first component temperature and to provide a first component temperature sensing signal;
a second temperature sensor disposed to measure a second component temperature and to provide a second component temperature sensing signal; and
an electronic controller configured to:
provide a motor command signal;
receive the first and second temperatures;
calculate a first temperature difference between the first temperature and the first temperature limit and generate a first blower command for the motor based on the first temperature difference;
calculate a second temperature difference between the second temperature and the second temperature limit to generate a second blower command for the motor based on the second temperature difference;
calculate a feed-forward blower motor command based on a machine load factor;
select the greater of the first blower command, the second blower command, and the feed-forward blower command to be a maximum command, and
determine and provide the motor command signal to the motor based on the maximum command.

8. The machine of claim 7, wherein the first component and the second component are at least two of a chopper circuit, an inverter circuit, a generator bearing, a generator winding, a motor bearing, a motor winding, a final drive, and a final drive oil cooler that are operably associated with the machine.

9. The machine of claim 7, further including an engine speed sensor disposed to measure a speed of an engine associated with the machine, wherein the electronic controller is configured to determine the load factor of the machine based at least partially on an engine speed signal provided to the electronic controller by the engine speed sensor.

10. The machine of claim 7, further including a speed sensor disposed to measure a rotational speed of the motor and communicate a fan speed to the electronic controller, wherein the electronic controller is disposed to use the fan speed in a closed loop control system that controls the operation of the fan motor.

11. The machine of claim 7, further including:
a pump operating to circulate a flow of fluid through conduits that are connected to the fan motor; and
a proportional valve disposed to selectively modulate a flow rate of the flow of fluid in the conduits;
wherein the fan motor is a hydrostatic motor whose rotational speed depends on a setting of the proportional valve, and
wherein the electronic controller is disposed to adjust the setting of the proportional valve.

12. The machine of claim 7, wherein the machine further includes a hollow drive axle forming a cavity, wherein the first component is a liquid-to-air cooler disposed at least partially within the cooling duct, the liquid-to-air cooler arranged to cool a flow of coolant circulating through a final drive of the machine.

13. A method of operating a blower disposed in a convective cooling system associated with at least a first component and a second component of a machine, the cooling system including a cooling duct that directs a cooling flow of air toward the first component and the second component, and a blower operating under the control of a controller to direct a cooling flow of air through the cooling duct, the method comprising:
sensing a first temperature of the first component and providing a first temperature signal indicative of the first temperature;
sensing a second temperature of the second component and providing a second temperature signal indicative of the second temperature;
comparing the first temperature signal to a first temperature limit to yield a first temperature difference;
comparing the second temperature signal to a second temperature limit to yield a second temperature difference;
calculating a first desired airflow based on the first temperature difference;
calculating a second desired airflow based on the second temperature difference;
determining a feed-forward airflow based on at least one operating parameter of the machine that is indicative of a load factor of the machine;
selecting the greater of the first desired airflow, the second desired airflow and the feed-forward airflow to be a maximum desired airflow; and
operating the blower to generate a flow of air in the cooling duct that is at least equal to the maximum desired airflow.

14. The method of claim 13, wherein determining the feed-forward airflow is based on an engine speed and a torque command of the machine.

15. The method of claim 13, further including measuring a rotational speed of the blower, wherein operating the blower is based on a feedback signal to the electronic controller that is indicative of the rotational speed.

16. The method of claim 13, further including:
impelling a flow of hydraulic fluid through the motor with a pump;
metering the flow of hydraulic fluid with a proportional valve; and
adjusting a command signal that controls the proportional valve;
wherein operating the blower to generate a flow of air in the cooling duct that is at least equal to the maximum desired airflow is accomplished by adjusting the command signal.
